(19) United States
(12) Patent Application Publication
(10) Pub. No.: US 2016/0205907 A1
(43) Pub. Date: Jul. 21, 2016

(54) Fishing Lure

(71) Applicant: John Ching Shieh, Taipei (TW)

(72) Inventor: John Ching Shieh, Taipei (TW)

(21) Appl. No.: 14/599,613

(22) Filed: Jan. 19, 2015

(51) Int. Cl. A01K 85/01

(52) U.S. Cl. CPC A01K 85/01

(57) ABSTRACT

A lure includes a lure body, an amino acids stick mounted in the lure body and dissolvable in water to give off a smell for baiting fish, and a sound-generating circuit board device for giving off sound to bait fish.

### BACKGROUND OF THE INVENTION

1. Field of the Invention

The present invention relates to fishing lures, and more particularly, to such a fishing lure, which uses sound and smell to bait fish.

2. Description of the Related Art

A fishing lure for rock fishing, river fishing or mountain stream fishing, generally has a lure body made to look like a fish. The lure body can be equipped with LEDs for giving off light to bait fish. However, the effect of using light to bait fish is limited. As fish is susceptible to sound and smell, providing a lure capable of giving off sound and smell can effectively bait fish.

### SUMMARY OF THE INVENTION

The present invention has been accomplished under the circumstances in view. It is the main object of the present invention to provide a fishing lure, which uses an amino acids stick for dissolving in water to generate a smell for baiting fish.

It is another object of the present invention to provide a fishing lure, which is equipped with a sound generating circuit board for generating sound to bait fish.

### BRIEF DESCRIPTION OF THE DRAWING

FIG. 1 is an exploded view of a fishing lure in accordance with the present invention.

FIG. 2 is an oblique top elevational view of a fishing lure in accordance with the present invention.

### DETAILED DESCRIPTION OF THE INVENTION

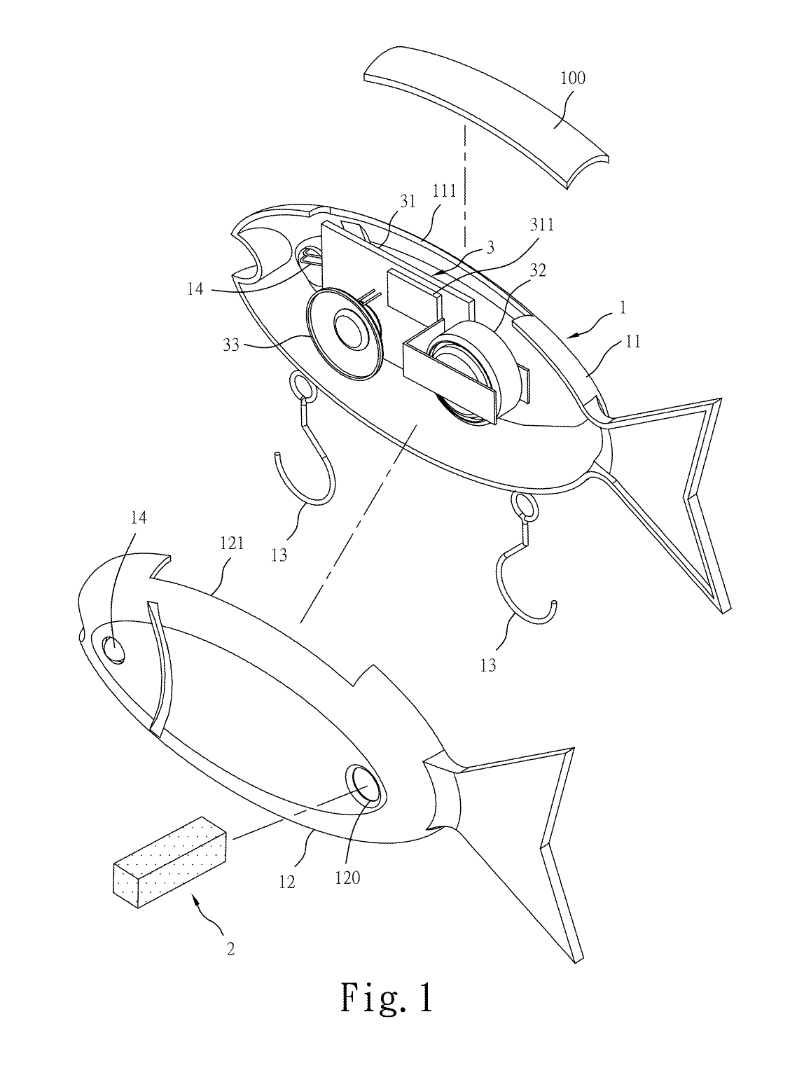

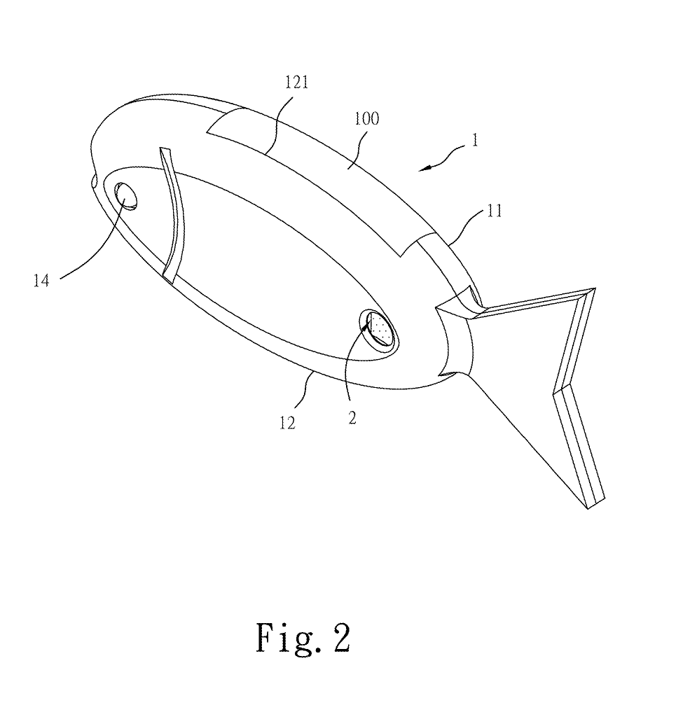

Referring to FIGS. 1 and 2, a fishing lure in accordance with the present invention is shown. The fishing lure comprises a lure body 1 made to look like a fish and consisting of a first body shell 11 and a second body shell 12 bonded together using ultrasonic sealing technology, a plurality of hooks 13 pivotally connected to the lure body 1 for catching fish, and LED lights 14 mounted in the first body shell 11 and the second body shell 12 for giving off light to bait fish.

The fishing lure is characterized in that at least one amino acids stick 2 is mounted in the lure body 1 and partially exposed to the outside of the first body shell 11 and/or the second body shell 12 and dissolvable in water to give off a smell for baiting fish, and a sound-generating circuit board device 3 mounted in the first body shell 11 or second body shell 12 of the lure body 1 for giving off sound to bait fish. Further, at least one locating hole 120 is located in the first body shell 11 and/or the second body shell 12 for accommodating the amino acids stick 2.

The aforesaid amino acids stick 2 is a stick of absorptive material such as a sponge stick, a woven fabric stick, or a non-woven fabric stick soaked in an amino acid solution and then dried.

Further, the aforesaid sound-generating circuit board device 3 comprises a circuit board control module 31, a battery 32, and a mini speaker 33. The battery 32 is electrically coupled to the circuit board control module 31 to provide the necessary working power supply. The mini speaker 33 is electrically coupled to the circuit board control module 31, and controllable by the circuit board control module 31 to output sound. The circuit board control module 31 comprises an audio IC 311 having a predetermined sound recorded therein. Further, the circuit board control module 31 is electrically connected with the LED lights 14.

Further, at least one notch 111;121 is located in the first body shell 11 and/or the second body shell 12, and sealed with at least one sealing cover 100.

In conclusion, the invention provides a fishing lure that has the advantages and features as follows:

1. The fishing lure is equipped with at least one amino acids stick 2 that is dissolvable in water to give off a smell for baiting hook.
2. The fishing lure is equipped with a sound-generating circuit board device 3 adapted for giving off sound to bait fish.

What is claimed is:

1. A fishing lure, comprising a lure body made to look like a fish, said lure body comprising a first body shell and a second body shell bonded together using ultrasonic sealing technology, at least one notch located in at least one of said first body shell and said second body shell, and at least one sealing cover covering said at least one notch, and a plurality of hooks pivotally connected to said lure body for catching fish, wherein the fishing lure further comprises an amino acids stick mounted in said lure body and exposed to the outside of at least one of said first body shell and said second body shell and dissolvable in water to give off a smell for bating fish, and a sound-generating circuit board device mounted in one of said first body shell and said second body shell for generating sound to bait fish.

2. The fishing lure as claimed in claim 1, wherein each said amino acids stick is a stick of absorptive material soaked in an amino acid solution and then dried; said lure body comprises at least one locating hole located in said first body shell and/or said second body shell for accommodating said at least one amino acids stick.

3. The fishing lure as claimed in claim 1, wherein said stick of absorptive material is selected from the group of sponge stick, woven fabric stick and non-woven fabric stick.

4. The fishing lure as claimed in claim 1, wherein said sound-generating circuit board device comprises a circuit board control module, a battery and a mini speaker, said battery being electrically coupled to said circuit board control module to provide the necessary working power supply, said mini speaker being electrically coupled to said circuit board control module and controllable by said circuit board control module to output sound, said circuit board control module comprising an audio IC having a predetermined sound recorded therein.
